(19) United States
(12) Patent Application Publication
(10) Pub. No.: US 2020/0195699 A1
(43) Pub. Date: Jun. 18, 2020

(54) DEVICE SETTING APPARATUS, DEVICE SETTING METHOD, DEVICE SETTING SYSTEM AND NON-TRANSITORY COMPUTER-READABLE RECORDING MEDIUM STORING DEVICE SETTING PROGRAM

(71) Applicant: SHARP KABUSHIKI KAISHA, Sakai City (JP)

(72) Inventors: YUUKI IWAMOTO, Sakai City (JP); KEIKO HIRUKAWA, Sakai City (JP)

(21) Appl. No.: 16/711,053

(22) Filed: Dec. 11, 2019

(30) Foreign Application Priority Data
Dec. 17, 2018 (JP) 2018-235542

(51) Int. Cl. H04L 29/06; H04N 7/15

(52) U.S. Cl. CPC H04L 65/4038; H04N 7/155

(57) ABSTRACT

A device setting system is provided with a server apparatus, and a device setting apparatus connected communicatably with the server apparatus. The server apparatus includes a setting storage to store second conference information defining a conference and setting information of a device in association with each other. The device setting apparatus is provided with a receiver, an extractor, and a setting executor. The receiver receives first conference information that is different than the second conference information. The extractor extracts the setting information corresponding to the first conference information from among the setting information stored in the setting storage of the server apparatus. The setting executor executes setting processing of the device based on the setting information.

### BACKGROUND OF THE INVENTION

### Field of the Invention

The present invention relates to a device setting apparatus, a device setting method, a device setting system and a non-transitory computer-readable recording medium storing a device setting program.

### Description of the Background Art

The technology for using a device arranged in a conference room is known. The device includes, for example, a speaker, and a microphone.

A conference environment management device described in, for example. Japanese Unexamined Patent Application Publication No. 2008-310533 includes a conference environment information storage, a message transceiver, and a controller. The conference environment information storage stores information relating to a device provided in a plurality of conference rooms, and information indicating whether the device is in a useable state in each conference room. The message transceiver receives a message in which the selection conditions for selecting a conference room to be used for the conference was input. The controller detects a conference room that meets with the selection conditions and includes the device in a useable state by referring to the conference environment information storage.

However, in the conference environment management device described in Japanese Unexamined Patent Application Publication No. 2008-310533, there is the possibility that it takes time to perform the setting of a device arranged in the conference room. For example, when a conference is started, the sound of the speaker may be too low, and the resolution setting of the camera may be too low.

### SUMMARY OF THE INVENTION

In consideration of the aforementioned problems, it is the object of the present disclosure to provide a device setting apparatus, a device setting method, a device setting system and a non-transitory computer-readable recording medium storing a device setting program that can be appropriately set in a device.

A device setting apparatus according to the present disclosure is provided with a receiver, a setting storage, an extractor, and a setting executor. The receiver receives first conference information defining a conference. The setting storage stores second conference information that is different than the first conference information and setting information of a device in association with each other. The extractor extracts the setting information corresponding to the first conference information from among the setting information stored in the setting storage. The setting executor executes setting processing of the device based on the setting information.

A device setting method according to the present disclosure is a device setting method executed by the device setting apparatus provided with a setting storage that stores second conference information defining a conference and setting information of a device in association with each other, and includes receiving, extracting, and setting. In the receiving, the device setting apparatus receives first conference information that is different than the second conference information. In the extracting, the device setting apparatus extracts the setting information corresponding to the first conference information from among the setting information stored in the setting storage. In the setting, the device setting apparatus executes setting processing of the device based on the setting information.

A device setting system according to the present disclosure is provided with a server apparatus, and a device setting apparatus connected communicatably with the server apparatus. The server apparatus includes a setting storage to store second conference information defining a conference and setting information of a device in association with each other. The device setting apparatus is provided with a receiver, an extractor and a setting executor. The receiver receives first conference information that is different than the second conference information. The extractor extracts the setting information corresponding to the first conference information from among the setting information stored in the setting storage of the server apparatus. The setting executor executes setting processing of the device based on the setting information.

A non-transitory computer-readable recording medium storing a device setting program according to the present disclosure causes a computer included in a device setting apparatus to function as a receiver, a setting storage, an extractor and a setting executor. The receiver receives first conference information defining a conference. The setting storage stores second conference information that is different than the first conference information is association with setting information of the device. The extractor extracts the setting information corresponding to the first conference information from among the setting information stored in the setting storage. The setting executor executes setting processing of the device based on the setting information.

The device setting apparatus, the device setting method, the device setting system and the non-transitory computer-readable recording medium storing the device setting program according to the present disclosure can be appropriately provided in a device.

### BRIEF DESCRIPTION OF THE DRAWINGS

FIG. 1 is a drawing illustrating an example of the configuration of a device setting system according to an embodiment of the present disclosure.

FIG. 2 is a drawing illustrating an example of the configuration of a device according to an embodiment of the present disclosure.

FIG. 3 is a drawing illustrating an example of the configuration of a first controller and a second controller according to an embodiment of the present disclosure.

FIG. 4 is a drawing illustrating an example of setting information according to an embodiment of the present disclosure.

FIG. 5 is a drawing illustrating an example of conference information according to an embodiment of the present disclosure.

FIG. 6 is a flowchart illustrating an example of the processing of the first controller according to an embodiment of the present disclosure.

FIG. 7 is a diagram of a screen illustrating an example of a setting completion screen.

FIG. 8 is a diagram of a screen illustrating an example of an alarm screen.

FIG. 9 is a flowchart illustrating an example of the processing of the first controller according to an embodiment of the present disclosure.

### DESCRIPTION OF THE PREFERRED EMBODIMENTS

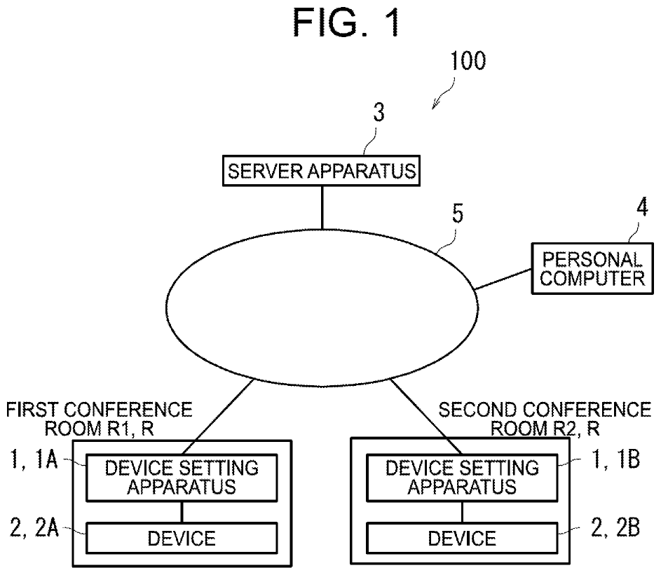

Hereinafter, an embodiment of the present disclosure will be described with reference to the drawings (FIG. 1 to FIG. 9). Note that, in the drawings, elements that are the same or substantially equivalent are labelled using the same reference signs and an explanation thereof will not be repeated.

First, the configuration of a device setting system 100 according to an embodiment of the present disclosure will be described with reference to FIG. 1. FIG. 1 is a drawing illustrating an example of the configuration of the device setting system 100. As illustrated in FIG. 1, the device setting system 100 is provided with a device setting apparatus 1, a device 2, a server apparatus 3, a personal computer 4 and a network 5.

The device setting apparatus 1 executes the setting processing of the device 2. The device setting apparatus 1 is provided with, for example, a personal computer. The device setting apparatus 1 includes a device setting apparatus 1A and a device setting apparatus 1B. The device setting apparatus 1A and the device setting apparatus 1B include the same substantial configuration.

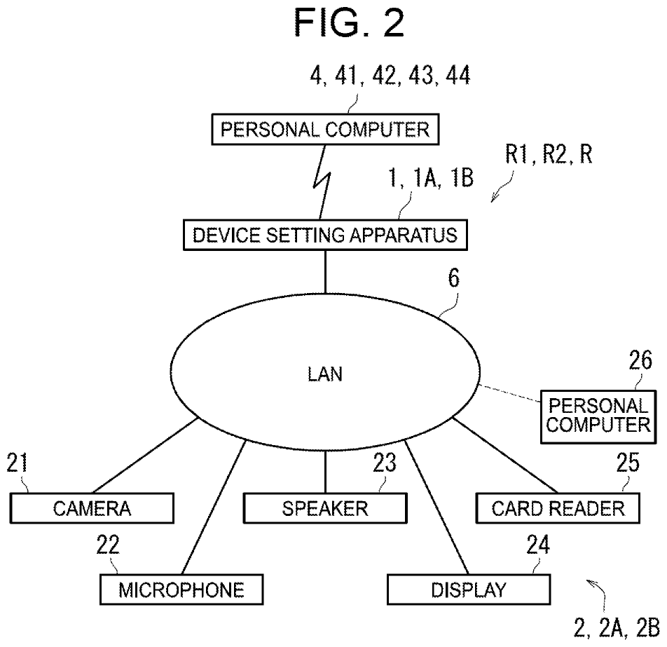

The device 2 indicates a device used in a conference. The device 2 includes a device 2A and a device 2B. The device 2A is connected communicatably with the device setting apparatus 1A, and is set by the device setting apparatus 1A. The device 2B is connected communicatably with the device setting apparatus 1B, and is set by the device setting apparatus 1B. The device 2A and the device 2B include the same substantial configuration. The device 2 will be described in detail later with reference to FIG. 2.

The device setting apparatus 1A and the device 2A are arranged in a first conference room R1. The device setting apparatus 1B and the device 2B are arranged in a second conference room R2. In the following description, each of the first conference room R1 and the second conference room R2 may be described as conference room R.

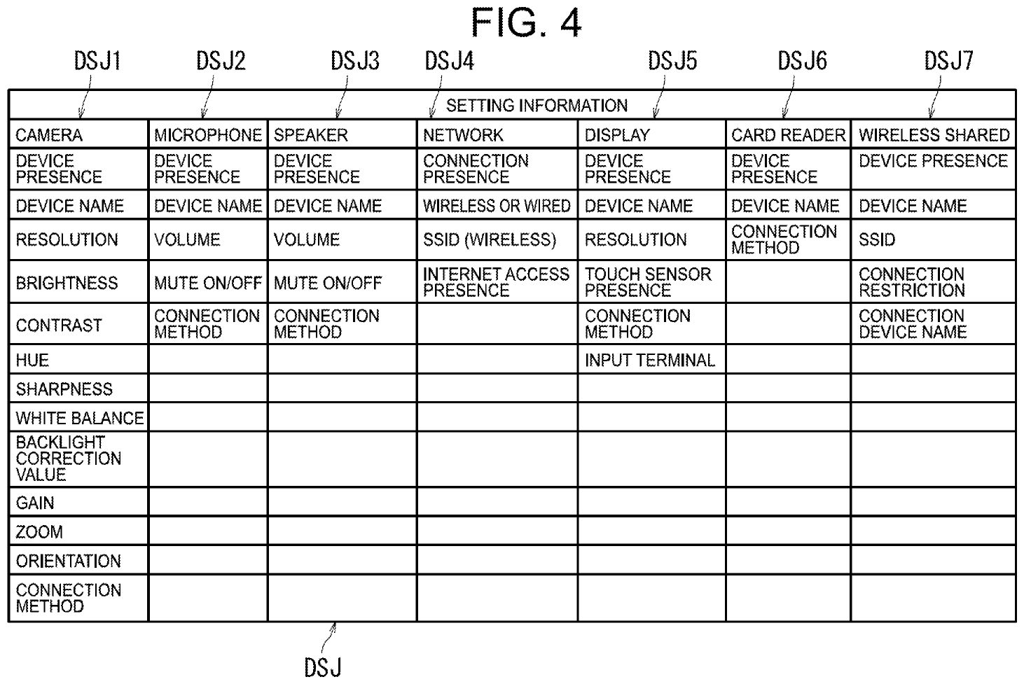

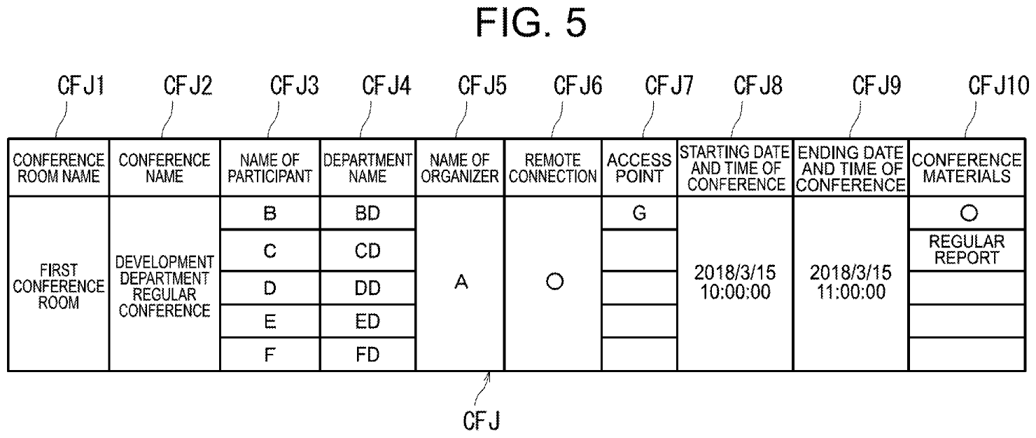

The server apparatus 3 stores conference information CFJ and setting information DSJ of the device 2 in association with each other. The conference information CFJ will be described in detail later with reference to FIG. 5. The setting information DSJ will be described in detail later with reference to FIG. 4.

The personal computer 4 is arranged at a remote location relative to the locations of each of the first conference room R1 and the second conference room R2. The personal computer 4 is operated by a user at a remote location. Further, via the personal computer 4, the user at a remote location attends the conference being held in the first conference room R1 or the second conference room R2.

The network 5 is connected so that the device setting apparatus 1 can communicate with the server apparatus 3. Further, the network 5 is connected so that the device setting apparatus 1 can communicate with personal computer 4. The network 5 is, for example, the Internet. Note that, in the embodiment of the present disclosure, the network 5 is the Internet, but the present disclosure is not limited thereto. The network 5 may be connected so that the device setting apparatus 1 can communicate with the server apparatus 3, and may be connected so that the device setting apparatus 1 can communicate with the personal computer 4. The network 5 may be, for example, a wide area network (WAN).

Next, the configuration of the device 2 will be described with reference to FIG. 1 and FIG. 2. FIG. 2 is a drawing illustrating an example of the configuration of the device 2. As illustrated in FIG. 2, the device 2 includes a camera 21, a microphone 22, a speaker 23, a display 24, a card reader 25 and a personal computer 26. Each of the camera 21, the microphone 22, the speaker 23, the display 24, the card reader 25 and the personal computer 26 is connected via a LAN 6 communicatably with the device setting apparatus 1.

The camera 21 captures a moving image of the participant of the conference and a moving image of the screen displayed on the display 24, and generates moving image information MJ. The moving image information MJ is transmitted from the camera 21 to the device setting apparatus 1.

The microphone 22 acquires the voices of the participants of the conference and outputs voice information SJ. The voice information SJ is transmitted from the microphone 22 to the device setting apparatus 1.

The speaker 23 outputs the voice of the participant of the conference. For example, when a participant at a remote location is included, the speaker 23 outputs the voice of the participant at the remote location to the participants of the conference. Specifically, the participant at a remote location uses the personal computer 4 to attend the conference.

Specifically, the personal computer 4 and the device setting apparatus 1 are connected via the network illustrated in FIG. 1. The personal computer 4 is provided with a microphone 41, a speaker 42, a display 43 and a camera 44. The voice input into the microphone 41 of the personal computer 4 is output from the speaker 23. Further, a voice input into the microphone 22 is output from the speaker 42 of the personal computer 4. Further, the moving image information MJ generated by the camera 21 is displayed on the display 43 of the personal computer 4. The moving image information MJ generated by the camera 44 of the personal computer 4 is displayed on the display 24.

The display 24 displays numerous images, and numerous moving images. The display 24 displays, for example, the moving image of the participant at a remote location. Further, the display 24 displays, for example, an image stored in the personal computer 26. The image stored in the personal computer 26 is, for example, a slide image.

The card reader 25 reads user information UJ recorded on the card. The card is, for example, an integrated circuit (IC) card, and the card reader 25 reads the user information UJ by near field communication. The near field communication is, for example, a Bluetooth (Registered trademark). The user information UJ includes the participant name information PMNJ of the conference and the department name information PMDJ that is the affiliation of the participant of the conference. The user information UJ is transmitted from the card reader 25 to the device setting apparatus 1.

The personal computer 26, for example, is brought into the conference room R by a participant of the conference. The personal computer 26 is connected communicatably with the device 2 via the LAN 6. The personal computer 26 stores, for example, a slide image. The slide image stored in the personal computer 26 is displayed on the display 24.

The LAN 6 is connected with each of the camera 21, the microphone 22, the speaker 23, the display 24, the card reader 25 and the personal computer 26 communicatably with the device setting apparatus 1. Further, the LAN 6 is connected with each of the camera 21, the microphone 22, the speaker 23, the display 24 and the card reader 25 communicatably with the personal computer 26. LAN 6 is, for example, a wireless LAN. Note that, in the embodiment of the present disclosure, the LAN 6 is a wireless LAN, but the present disclosure is not limited thereto. The LAN 6 may be a wired LAN. Further, each of the camera 21, the microphone 22, the speaker 23, the display 24, the card reader 25 and the personal computer 26 may be connected with the device setting apparatus 1 by cables. For example, the display 24 and the device setting apparatus 1 may be connected by a high-definition multimedia interface (HDMI (Registered trademark)) cable. Each of the camera 21 and the microphone 22 and the device setting apparatus 1 may be connected by a universal serial bus (USB) cable.

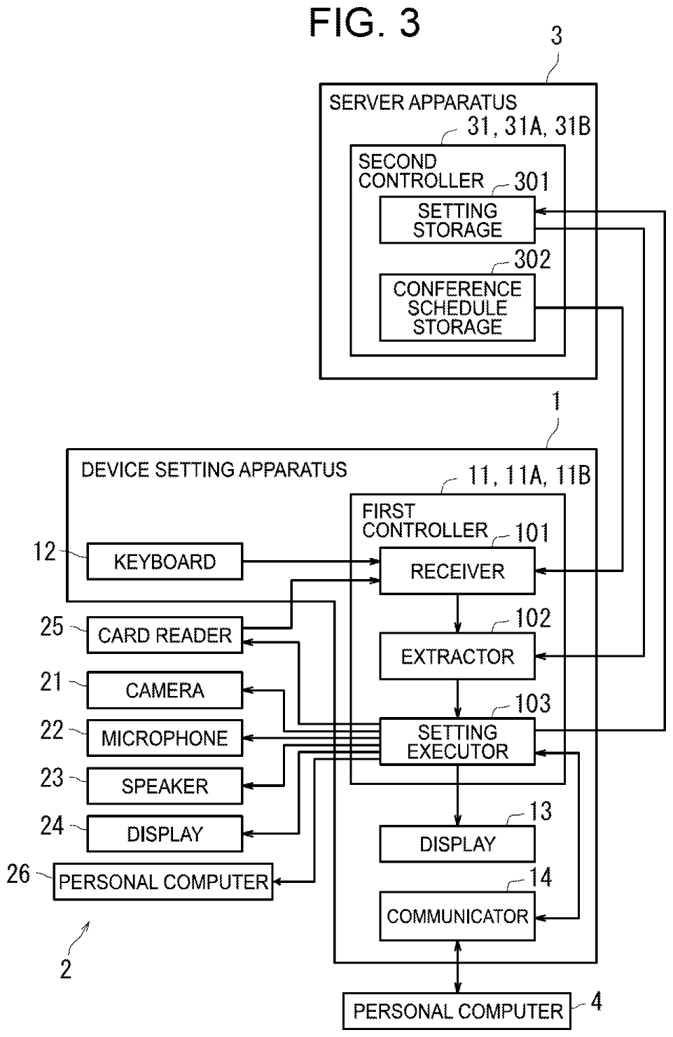

Next, the configurations of the first controller 11 and the second controller 31 according to the embodiment of the present disclosure will be described with reference to FIG. 1 to FIG. 3. FIG. 3 is a drawing illustrating an example of the configurations of the first controller 11 and the second controller 31. As illustrated in FIG. 3, the device setting apparatus 1 is provided with a first controller 11, a keyboard 12, a display 13 and a communicator 14. The server apparatus 3 is provided with a second controller 31.

The first controller 11 controls the operation of the device setting apparatus 1. The first controller 11 includes a processor 11A such as a central processing unit (CPU) and a storage device 11B. The storage device 11B includes a semiconductor memory. The storage device 11B may be provided with a hard disk drive (HDD). The storage device 11B stores a first control program. The first control program corresponds to an example of the “device setting program”.

The keyboard 12 receives the operation from a user. The keyboard 12 transmits an operation signal to the first controller 11. The operation signal indicates the operation.

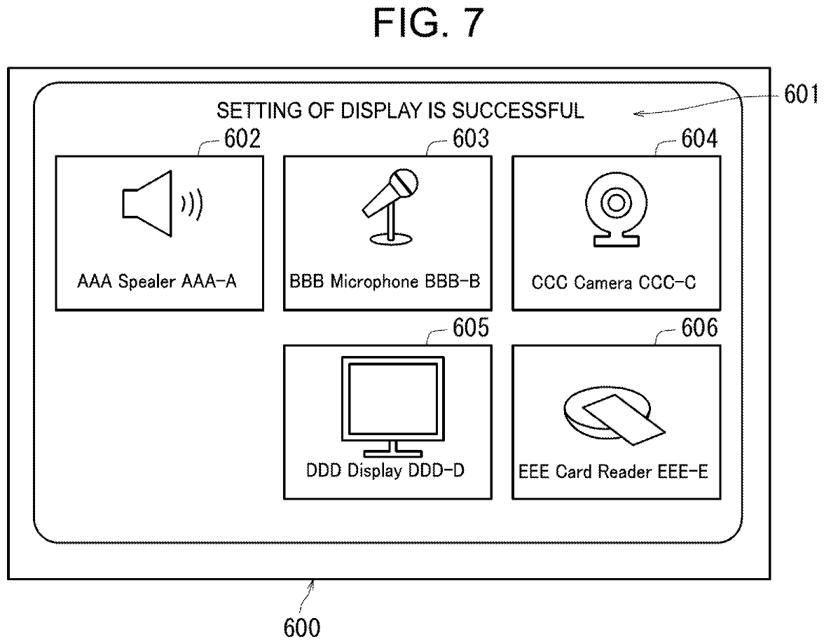

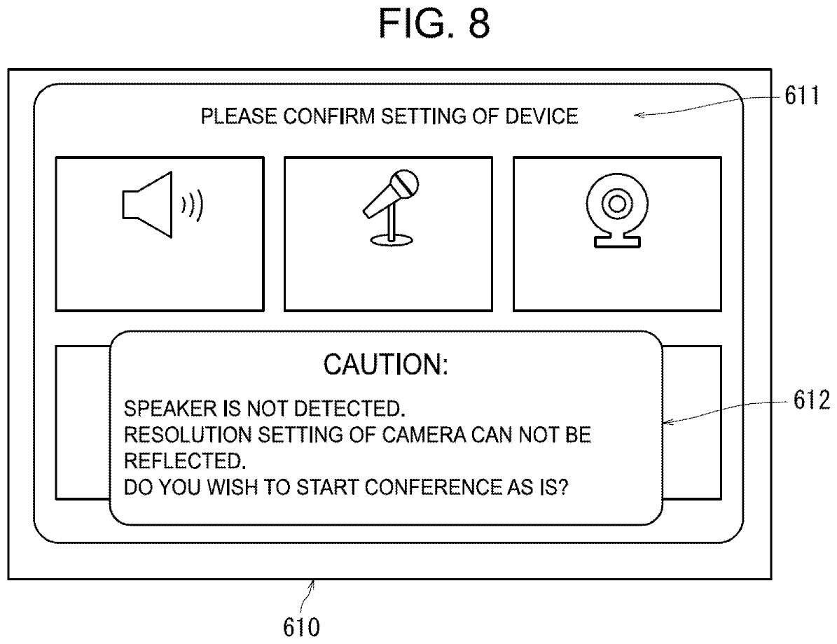

The display 13 is provided with, for example, a liquid crystal display (LCD), and displays numerous images. The display 13 displays, for example, a setting completion screen 600 and an alarm screen 610. The setting completion screen 600 will be described in detail later with reference to FIG. 7, and the alarm screen 610 will be described in detail later with reference to FIG. 8.

The communicator 14 connects the device 2 communicatably with the personal computer 4 of an access point AP. The communicator 14 corresponds to an example of a “network connection device”.

The second controller 31 controls the operation of the server apparatus 3. The second controller 31 includes a processor 31A such as a CPU and a storage device 31B. The storage device 31B includes a semiconductor memory. The storage device 31B may be provided with an HDD. The storage device 31B stores a second control program.

The storage device 31B of the second controller 31 is provided with a setting storage 301 and a conference schedule storage 302. Specifically, by the processor 31A of the second controller 31 executing the second control program, the processor 31A causes the storage device 31B to function as the setting storage 301 and the conference schedule storage 302.

The setting storage 301 stores second conference information CFJB and setting information DSJ of the device 2 in association with each other. The second conference information CFJB indicates the conference information CFJ relating to an ended conference. Further, the setting storage 301 stores default setting information DSJ. The setting information DSJ will be described in detail later with reference to FIG. 4.

The conference schedule storage 302 stores first conference information CFJA. The first conference information CFJA indicates the conference information CFJ relating to a scheduled conference. The conference information CFJ indicates the information defining the conference. The conference information CFJ will be described in detail later with reference to FIG. 5. In the following description, each of the first conference information CFJA and the second conference information CFJB may be described as the conference information CFJ. The conference information CFJ will be described in detail later with reference to FIG. 5.

Next, the configuration of the first controller 11 will be described. The first controller 11 is provided with a receiver 101, an extractor 102 and a setting executor 103. Specifically, the first controller 11 functions as the receiver 101, the extractor 102 and the setting executor 103 by the processor 11A of the first controller 11 executing the first control program.

The receiver 101 receives the first conference information CFJA. The receiver 101 receives, for example, conference name information CNJ. The conference name information CNJ indicates a conference name CN. The conference information CFJ includes the conference name information CNJ. The receiver 101 acquires the first conference information CFJA from the conference schedule storage 302 based on the conference name information CNJ.

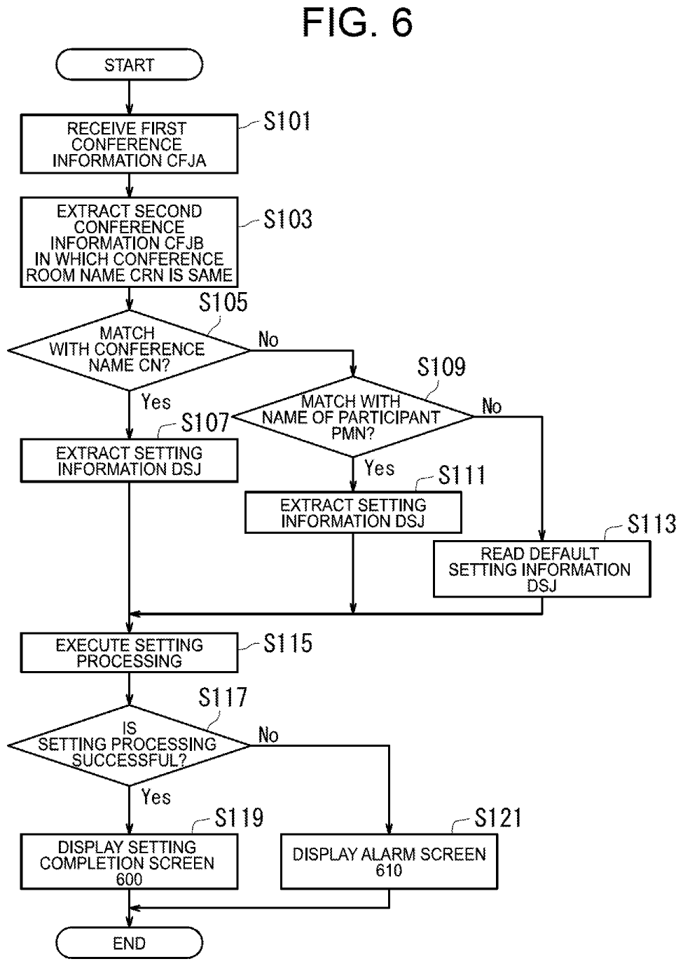

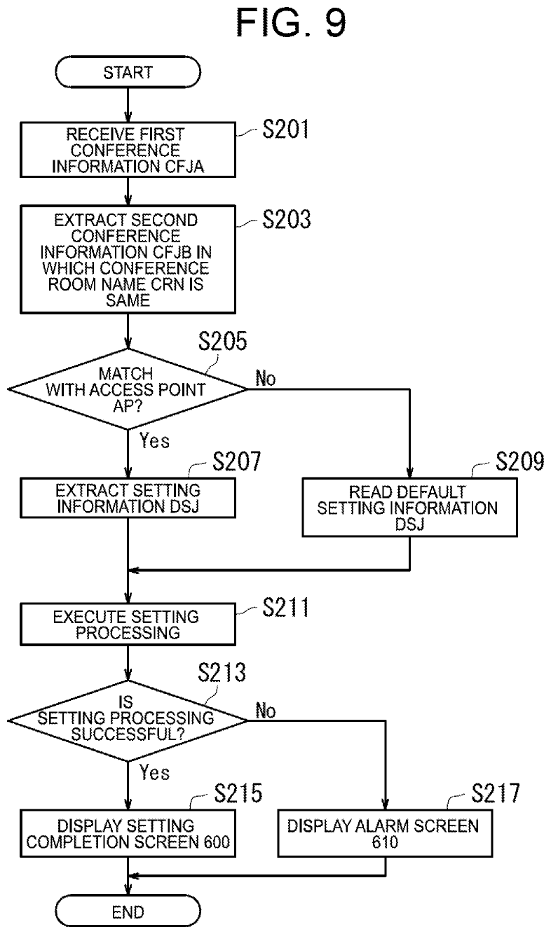

The extractor 102 extracts the setting information DSJ corresponding to the first conference information CFJA from among the setting information DSJ stored in the setting storage 301. The specific processing of the extractor 102 will be described in detail later with reference to FIG. 6 and FIG. 9.

The setting executor 103 executes the setting processing of the device 2 based on the setting information DSJ.

As described above with reference to FIG. 1 to FIG. 3, in the embodiment of the present disclosure, the setting storage 301 stores the second conference information CFJB and the setting information DSJ of the device 2 in association with each other. The extractor 102 extracts the setting information DSJ corresponding to the first conference information CFJA from among the setting information DSJ stored in the setting storage 301. The setting executor 103 executes the setting processing of the device 2 based on the setting information DSJ. For example, the second conference information CFJB in which a conference room name CRN and the conference name CN match with the first conference information CFJA is selected, and the setting processing of the device 2 is executed based on the setting information DSJ associated with the second conference information CFJB. Therefore, the device 2 can be appropriately set.

Note that, in the embodiment of the present disclosure, the second controller 31 of the server apparatus 3 includes the setting storage 301, but the present disclosure is not limited thereto. The first controller 11 of the device setting apparatus 1 may also include the setting storage 301. In this case, the setting information DSJ can be extracted in a short period of time.

Next, the setting information DSJ according to an embodiment of the present disclosure will be described with reference to FIG. 3 and FIG. 4. FIG. 4 is a drawing illustrating an example of the setting information DSJ. As illustrated in FIG. 4, the setting information DSJ includes first setting information DSJ1, second setting information DSJ2, third setting information DSJ3, fourth setting information DSJ4, fifth setting information DSJ5, sixth setting information DSJ6 and seventh setting information DSJ7.

The first setting information DSJ1 indicates the setting information of the camera 21. The setting executor 103 executes the setting processing of the camera 21 based on the first setting information DSJ1. The first setting information DSJ1 includes device presence information and detailed information. The detailed information includes device name information, resolution information, brightness information, contrast information, hue information, sharpness information, white balance information, backlight correction value information, gain information, zoom information, orientation information, and connection method information.

For example, the device presence information indicates whether a camera 21 is arranged in the conference room R. When a camera 21 is not arranged in the conference room R, the information is not input in the detailed information. The device name information indicates the model of the camera 21. The orientation information indicates the orientation of the camera 21. The camera 21 is configured so that the orientation is adjustable. The connection method information indicates the connection method between the camera 21 and the device setting apparatus 1.

The second setting information DSJ2 indicates the setting information of the microphone 22. The setting executor 103 executes the setting processing of the microphone 22 based on the second setting information DSJ2. The second setting information DSJ2 includes the device presence information, the device name information, volume information, mute information, and the connection method information. For example, the mute information indicates whether mute is on or off. When the mute is on, sound is not input in the microphone 22. When the mute is off, sound is input in the microphone 22.

The third setting information DSJ3 indicates the setting information of the speaker 23. The setting executor 103 executes the setting processing of the speaker 23 based on the third setting information DSJ3. The third setting information DSJ3 includes the device presence information, the device name information, the volume information, the mute information and the connection method information. For example, the mute information indicates whether mute is on or off. When the mute is on, sound is not output from the speaker 23. When the mute is off, sound is output from speaker 23.

The fourth setting information DSJ4 indicates the setting information of the communicator 14. The setting executor 103 executes the setting processing of the communicator 14 based on the fourth setting information DSJ4. The fourth setting information DSJ4 includes connection presence information, wired/wireless information, service set identifier (SSID) information, and internet access presence information.

For example, the connection presence information indicates whether the communicator 14 is connected with the personal computer 4. When the communicator 14 is not connected with the personal computer 4, information is not input into wired/wireless information, SSID information, and the internet access presence information. The wired/wireless information indicates whether the communicator 14 is connected with the personal computer 4, and whether the connection is wireless. The SSID information indicates identification information for identifying the access point of the wireless LAN. When the communicator 14 is connected wirelessly with the personal computer 4, the SSID information is set in the communicator 14. The internet access presence information indicates whether the communicator 14 is connected with the personal computer 4 via the network 5.

The fifth setting information DSJ5 indicates the setting information of the display 24. The setting executor 103 executes the setting processing of the display 24 based on the fifth setting information DSJ5. The fifth setting information DSJ5 includes the device presence information, the device name information, the resolution information, touch sensor presence information, the connection method information and input terminal information. For example, the touch sensor presence information indicates whether a touch sensor is arranged on the display screen of the display 24. The input terminal information indicates the terminal for inputting the image information corresponding to the image displayed on the display 24.

The sixth setting information DSJ6 indicates the setting information of the card reader 25. The setting executor 103 executes the setting processing of the card reader 25 based on the sixth setting information DSJ6. The sixth setting information DSJ6 includes the device presence information, the device name information, and the connection method information.

The seventh setting information DSJ7 indicates the setting information of a wireless shared device. The wireless shared device is included of a wireless LAN 6. The wireless shared device is, for example, wePresent (Product name) manufactured by Awind Inc., or Chromecast (Product name) manufactured by Google Inc. The wireless shared device is, for example, connected with the display 24 by a HDMI cable, and the other devices are connected by Wi-Fi. The setting executor 103 executes the setting processing of the wireless shared device based on the seventh setting information DSJ7. The seventh setting information DSJ7 includes the device presence information, the device name information, the SSID information, connection restriction information and connection device name information. For example, the device presence information indicates whether a wireless shared device is used. Further, for example, the connection device name information indicates the name of the wireless shared device. The SSID information indicates the SSID of the wireless shared device. The connection restriction information indicates the device that is able to be connected to the wireless shared device. The connection device name information indicates the device name to be wireless connected to the wireless shared device.

As described above with reference to FIG. 3 and FIG. 4, in the embodiment of the present disclosure, the device 2 includes the camera 21, the microphone 22, the speaker 23, the display 24, the card reader 25 and the personal computer 26. Therefore, the setting executor 103 executes the setting processing of each of the camera 21, the microphone 22, the speaker 23, the display 24, the card reader 25 and the personal computer 26.

Note that, in the embodiment of the present disclosure, the device 2 includes the camera 21, the microphone 22, the speaker 23, the display 24, the card reader 25 and the personal computer 26, but the present disclosure is not limited thereto. The device 2 includes at least one of the camera 21, the microphone 22, the speaker 23, the display 24 and the card reader 25.

Further, in the embodiment of the present disclosure, the communicator 14 of the device setting apparatus 1 is connected communicatably with the personal computer 4, but the present disclosure is not limited thereto. The device 2 is configured to be able to communicate via the personal computer 4 and the network 5. For example, the device 2 may also include a network connection device connected to a personal computer 4 via a network 5.

Next, the conference information CFJ according to an embodiment of the present disclosure will be described with reference to FIG. 3 to FIG. 5. FIG. 5 is a drawing illustrating an example of the conference information CFJ. As illustrated in FIG. 5, the conference information CFJ includes first information CFJ1, second information CFJ2, third information CFJ3, fourth information CFJ4, fifth information CFJ5, sixth information CFJ6, seventh information CFJ7, eighth information CFJ8, ninth information CFJ9 and tenth information CFJ10.

The first information CFJ1 indicates the conference room name CRN. For example, the conference room name CRN of the first conference room R1 is the first conference room. The conference room name CRN of the second conference room R2 is the second conference room. The first information CFJ1 corresponds to an example of “conference room name information”.

The second information CFJ2 indicates the conference name CN. The conference name CN is determined based on, for example, the purpose of the conference. In the embodiment of the present disclosure, the conference name CN is, for example, the “DEVELOPMENT DEPARTMENT REGULAR CONFERENCE”. The second information CFJ2 corresponds to an example of the “conference name information”.

The third information CFJ3 indicates the name of the participant PMN. For example, when there are five participants, the third information CFJ3 indicates the names of each of the five participants. The third information CFJ3 corresponds to an example of the “participant name information”.

The fourth information CFJ4 indicates the department name PMD. For example, when there are five participants, the fourth information CFJ4 indicates the department name PMD of each of the five participants.

The fifth information CFJ5 indicates the name of the organizer. The name of the organizer indicates the name of the person who organized the conference (or who called the conference to order).

The sixth information CFJ6 indicates the presence of a remote connection of the device 2. Specifically, the sixth information CFJ6 indicates whether the communicator 14 of the device setting apparatus 1 is connected with a personal computer 4.

The seventh information CFJ7 indicates the access point AP of the device 2. The access point AP may also be the name of the user operating the personal computer 4, and may be the location of the personal computer 4. Further, the access point AP may be the internet protocol address (IP address) of the personal computer 4. The seventh information CFJ7 corresponds to an example of “access destination information”.

The eighth information CFJ8 indicates the starting date and time ST of the conference. When the conference information CFJ is the first conference information CFJA, the eighth information CFJ8 indicates the scheduled starting date and time of the conference. The eighth information CFJ8 corresponds to an example of “starting date and time information”.

The ninth information CFJ9 indicates the ending date and time ET of the conference. When the conference information CFJ is the first conference information CFJA, the ninth information CFJ9 indicates the scheduled ending date and time of the conference. The ninth information CFJ9 corresponds to an example of “ending date and time information”.

The tenth information CFJ10 indicates conference materials. Specifically, the tenth information CFJ10 indicates the presence of conference materials and the name of the conference materials.

As described above with reference to FIG. 3 to FIG. 5, in the embodiment of the present disclosure, the conference information CFJ indicates the conference room name CRN, the conference name CN, the name of the organizer, the name of the participant PMN, the department name PMD of the participant corresponding to the name of the participant PMN, the presence of a remote connection, the access point AP of the device 2, the starting date and time ST and the ending date and time ET, but the present disclosure is not limited thereto. The conference information CFJ indicates at least one of the conference room name CRN, the conference name CN, the name of the organizer, the name of the participant PMN, the department name PMD of the participant corresponding to the name of the participant PMN, the presence of a remote connection, the access point AP of the device 2, the starting date and time ST and the ending date and time ET. The conference information CFJ preferably indicates the conference name CN, the name of the participant PMN and the access point AP of the device 2.

Further, in the embodiment of the present disclosure, there is one access point AP of the remote connection, but the present disclosure is not limited thereto. There may be two or more access points of the remote connection. For example, there may be two or more access points of the remote connection. In this case, the seventh information CFJ7 indicates two remoted connected access points AP.

Next, the processing of the first controller 11 of the device setting apparatus 1 according to an embodiment of the present disclosure will be described with reference to FIG. 3 to FIG. 6. FIG. 6 is a flowchart illustrating an example of the processing of the first controller 11. As illustrated in FIG. 6, first, in step S101, the receiver 101 receives the first conference information CFJA. Next, in step S103, the extractor 102 extracts the second conference information CFJB in which the conference room name CRN is the same as the conference room name CRN of the first conference information CFJA from among the second conference information CFJB stored in the setting storage 301. Next, in step S105, the extractor 102 determines whether the conference name CN of the first conference information CFJA matches with the conference name CN of the second conference information CFJB. When the extractor 102 determined that the conference name CN matches (YES in step S105), the processing proceeds to step S107. Moreover, in step S107, the extractor 102 extracts the setting information DSJ associated with the second conference information CFJB. Then, the processing proceeds to step S115.

When the extractor 102 determined that the conference name CN does not match (NO in step S105), the processing proceeds to step S109. Moreover, in step S109, the extractor 102 determines whether the name of the participant PMN of the first conference information CFJA matches with name of the participant PMN of the second conference information CFJB. Specifically, the extractor 102 determines whether the number of people whose names of the participants PMN of the first conference information CFJA match with the names of the participants PMN of the second conference information CFJB are a predetermined ratio of the total number of participants or more. The predetermined ratio, is, for example, 70%. When the extractor 102 determined that the name of the participant PMN matches (YES in S109), the processing proceeds to step S111. Moreover, in step S111, the extractor 102 extracts the setting information DSJ associated with the second conference information CFJB. Then, the processing proceeds to step S115.

When the extractor 102 determined that the name of the participant PMN does not match (NO in step S109), the processing proceeds to step S113. Moreover, in step S113, the extractor 102 reads the default setting information DSJ from the setting storage 301. Next, in step S115, the setting executor 103 executes the setting processing of the device 2 based on the setting information DSJ. Next, in step S117, the setting executor 103 determines whether the setting processing of the device 2 is successful. Specifically, the setting executor 103 determines that the setting processing is successful when the setting executor 103 could execute the setting processing of the device 2 according to the setting information DSJ. The setting executor 103 determines that the setting processing is not successful when the setting executor 103 could not execute the setting processing of the device 2 according to the setting information DSJ.

When the setting executor 103 determined that the setting processing is successful (YES in step S117), the processing proceeds to step S119. Moreover, in step S119, the setting executor 103 displays the setting completion screen 600 on the display 13. Then, the processing is ended. The setting completion screen 600 indicates that the setting processing is successful. The setting completion screen 600 will be described in detail below with reference to FIG. 7. When the setting executor 103 determined that the setting processing is not successful (NO in step S117), the processing proceeds to step S121. Moreover, in step S121, the setting executor 103 displays the alarm screen 610 on the display 13. Then, processing is ended. The alarm screen 610 indicates that the setting processing is not successful. The alarm screen 610 will be described in detail below with reference to FIG. 8.

Step S101 corresponds to an example of the “receiving”. Step S103 to step S113 correspond to an example of the “extracting”. Step S115 corresponds to an example of the “setting”.

As illustrated above with reference to FIG. 3 to FIG. 6, in the embodiment of the present disclosure, the extractor 102 extracts the setting information DSJ corresponding to the first information CFJ1 (conference room name information) and the second information CFJ2 (the conference name information CNJ) of the first conference information CFJA from among the setting information DSJ stored in the setting storage 301. Specifically, for example, the first conference information CFJA and the second conference information CFJB in which the conference room name CRN and the conference name CN match are extracted. Moreover, the setting information DSJ associated with the second conference information CFJB is extracted. Therefore, the setting information DSJ that is appropriate, of the device 2 can be extracted. Therefore, the device 2 can be further appropriately set.

Further, the extractor 102 extracts the setting information DSJ corresponding to the third information CFJ3 (participant name information) of the first conference information CFJA from among the setting information DSJ stored in the setting storage 301. For example, the extractor 102 extracts the second conference information CFJB in which the conference room name CRN and the name of the participant PMN match with the first conference information CFJA. Moreover, the setting information DSJ associated with the second conference information CFJB is extracted. Therefore, the setting information DSJ that is appropriate, of the device 2 can be extracted. Therefore, the device 2 can be further appropriately set.

Note that, in the embodiment of the present disclosure, the extractor 102 extracts the setting information DSJ corresponding to the third information CFJ3 (participant name information) of the first conference information CFJA, but the present disclosure is not limited thereto. The extractor 102 may extract the setting information DSJ corresponding to the first conference information CFJA.

For example, the extractor 102 may also extract the setting information DSJ corresponding to the fourth information CFJ4 (department name PMD) of the first conference information CFJA. In this case, in the case of a conference in which the participants are not specified, and representatives from each department attend, the extractor 102 can extract the setting information DSJ that is appropriate.

Further, for example, the extractor 102 may also extract the setting information DSJ based on at least one of the eighth information CFJ8 (starting date and time information) and the ninth information CFJ9 (ending date and time information) of the first conference information CFJA.

Specifically, the setting information DSJ may also be extracted based on the starting date and time ST and the ending date and time ET of first conference information CFJA. For example, when the date and time of N-weeks ago (N is predetermined natural number) of the starting date and time ST of the first conference information CFJA matches with the starting date and time ST of the second conference information CFJB, and the date and time of N-weeks ago of the ending date and time ET of the first conference information CFJA matches with the ending date and time ET of the second conference information CFJB, the extractor 102 extracts the setting information DSJ corresponding to the second conference information CFJB. The N-weeks is, for example, 2 weeks.

In this case, the setting information DSJ that is appropriate, of the device 2 can be extracted at conferences held regularly (for example, biweekly).

Next, the setting completion screen 600 will be described with reference to FIG. 3 to FIG. 7. FIG. 7 is a diagram of a screen illustrating an example of the setting completion screen 600. The setting completion screen 600 is displayed on the display 13 by the setting executor 103, as illustrated in step S119 of FIG. 6. As illustrated in FIG. 7, the setting completion screen 600 includes a message display device 601, a first setting display device 602, a second setting display device 603, a third setting display device 604, a fourth setting display device 605 and a fifth setting display device 606.

The message display device 601 displays a message that the setting processing of the device 2 is successful. For example, the message display device 601 displays the message “SETTING OF DEVICE IS SUCCESSFUL”.

The first setting display device 602 displays the third setting information DSJ3 (setting information of the speaker 23) illustrated in FIG. 4. The first setting display device 602 displays, for example, the device name information of the speaker 23.

The second setting display device 603 displays the second setting information DSJ2 (setting information of the microphone 22) illustrated in FIG. 4. The second setting display device 603 displays, for example, the device name information of the microphone 22.

The third setting display device 604 displays the first setting information DSJ1 (setting information of the camera 21) illustrated in FIG. 4. The third setting display device 604 displays, for example, the device name information of the camera 21.

The fourth setting display device 605 displays the fifth setting information DSJ5 (setting information of the display 24) illustrated in FIG. 4. The fourth setting display device 605 displays, for example, the device name information of the display 24.

The fifth setting display device 606 displays the sixth setting information DSJ6 (setting information of the card reader 25) illustrated in FIG. 4. The fifth setting display device 606 displays, for example, the device name information of the card reader 25.

As described above with reference to FIG. 3 to FIG. 7, in the embodiment of the present disclosure, a message that the setting processing of the device 2 is successful is displayed on the setting completion screen 600, thus, the user can confirm that the setting processing is successful. Therefore, the convenience for the user can be improved.

Further, the setting information of the device 2 is displayed on the setting completion screen 600, thus, the user can confirm the setting information of the device 2. Therefore, the convenience for the user can be further improved.

Next, the alarm screen 610 will be described with reference to FIG. 3 to FIG. 8. FIG. 8 is a diagram of a screen illustrating an example of the alarm screen 610. The alarm screen 610 is displayed on the display 13 by the setting executor 103, as illustrated in step S121 or FIG. 6. As illustrated in FIG. 8, the alarm screen 610 includes the message display device 611 and the situation display device 612.

The message display device 611 displays the message that the setting processing of the device 2 failed. For example, the message display device 611 displays “PLEASE CONFIRM SETTING OF DEVICE” as the message.

The situation display device 612 displays the message illustrating the situation of the setting processing of the device 2. For example, the situation display device 612 displays “CAUTION: SPEAKER IS NOT DETECTED. RESOLUTION SETTING OF CAMERA CAN NOT BE REFLECTED. DO YOU WISH TO START CONFERENCE AS IS?” as the message.

The message “SPEAKER IS NOT DETECTED” illustrates, for example, the following condition. That is, in the setting information DSJ extracted by the extractor 102, the device presence information of the third setting information DSJ3 illustrated in FIG. 4 indicates that the speaker 23 is arranged in the conference room R. However, the setting executor 103 could not detect the speaker 23.

The message “RESOLUTION SETTING OF CAMERA CAN NOT BE REFLECTED” illustrates, for example, the following condition. That is, in the setting information DSJ extracted by the extractor 102, the setting executor 103 could not execute the setting processing of the resolution of the camera 21 along with the resolution information of the first setting information DSJ1 illustrated in FIG. 4.

The message “DO YOU WISH TO START CONFERENCE AS IS?” means that the setting of the speaker 23 and the camera 21 is not set according to the setting information DSJ, but the user determines whether to start the conference in this state. The user responds to this message as follows. When starting the conference in this state, the user, for example, presses the Enter key of a keyboard 12 to hide the alarm screen 610. On the one hand, the user performs the operations, for example, when setting the speaker 23 and the camera 21 to the default setting information DSJ.

As described above with reference to FIG. 3 to FIG. 8, in the embodiment of the present disclosure, the alarm screen 610 displays a message that the setting processing of the device 2 failed, thus, the user can confirm that the setting processing failed. Therefore, the convenience for the user can be further improved.

Further, the alarm screen 610 displays a message indicating the state of the setting processing of the device 2, thus, the user can confirm the state of the setting processing. Therefore, the convenience for the user can be further improved.

Next, the processing of the first controller 11 of the device setting apparatus 1 according to an embodiment of the present disclosure will be described with reference to FIG. 3 to FIG. 9. FIG. 9 is a flowchart illustrating an example of the processing of the first controller 11. The processing of the first controller 11 illustrated in FIG. 9 is different from the processing of the first controller 11 illustrated in FIG. 6 in the point that the extractor 102 extracts the setting information DSJ based on the access point AP.

As illustrated in FIG. 9, first, in step S201, the receiver 101 receives the first conference information CFJA. Next, in step S203, the extractor 102 extracts the second conference information CFJB in which the conference room name CRN is the same as the conference room name CRN of the first conference information CFJA from among the second conference information CFJB stored in the setting storage 301. Next, in step S205, the extractor 102 determines whether the access point AP of the first conference information CFJA matches with the access point AP of the second conference information CFJB. When the extractor 102 determined that the access points AP match (YES in step S205), the processing proceeds to step S207. Moreover, in step S207, the extractor 102 extracts the setting information DSJ associated with the second conference information CFJB. Then, the processing proceeds to step S211.

When the extractor 102 determined that the access points AP do not match (NO in step S205), the processing proceeds to step S209. Moreover, in step S209, the extractor 102 reads out the default setting information DSJ from the setting storage 301. Next, in step S211, the setting executor 103 executes the setting processing of the device 2 based on the setting information DSJ. Next, in step S213, the setting executor 103 determines whether the setting processing of the device 2 is successful. When the setting executor 103 determined that the setting processing is successful (YES in step S213), the processing proceeds to step S215. Moreover, in step S215, the setting executor 103 displays the setting completion screen 600 illustrated in FIG. 7 on the display 13. Then, the processing ends. When the setting executor 103 determined that the setting processing is not successful (NO in step S213), the processing proceeds to step S217. Moreover, in step S217, the setting executor 103 displays the alarm screen 610 illustrated in FIG. 8 on the display 13. Then, the processing ends.

Step S201 corresponds to an example of the “receiving”. Step S203 to step S209 correspond to an example of the “extracting”. Step S211 corresponds to an example of the “setting”.

As described above with reference to FIG. 3 to FIG. 9, in the embodiment of the present disclosure, the extractor 102 extracts the setting information DSJ corresponding to the first information CFJ1 (conference room name information) and the seventh information CFJ7 (access destination information) of the first conference information CFJA from among the setting information DSJ stored in the setting storage 301. For example, the second conference information CFJB in which the conference room name CRN and the access point AP matches with the first conference information CFJA is extracted. Moreover, the setting information DSJ associated with the second conference information CFJB is extracted. Therefore, the setting information DSJ that is appropriate, of the device 2 can be extracted. Therefore, the device 2 can be further appropriately set.

Note that, in the embodiment of the present disclosure, the extractor 102 extracts the setting information DSJ in which the access points AP match, but the present disclosure is not limited thereto. When there are two or more access points AP, the extractor 102 may extract the setting information DSJ that matches with at least one access point AP among the two or more access points AP.

The embodiment of the present disclosure is described above with reference to the drawings. However, the present disclosure is not limited to the aforementioned embodiment, and may be implemented in various different forms that do not deviate from the essence of the present invention (for example, the following (1) and (2)). Further, the elements of configuration disclosed in the above embodiment can be combined as appropriate to form various inventions. For example, some of the elements of configuration in the embodiment may be omitted. Furthermore, the elements of configuration in different embodiments may be combined as appropriate. The drawings schematically illustrate the elements of configuration in order to facilitate understanding and properties of the elements of configuration illustrated in the drawings, such as thickness, length, number, and spacing may differ from actual properties thereof in order to facilitate preparation of the drawings. Further, properties of elements of configuration described in the above embodiment, such as material properties, shapes, and dimensions, are merely examples and are not intended as specific limitations. Various alterations may be made so long as there is no substantial deviation from the effects of the present invention.

(1) As described with reference to FIG. 1, in the embodiment of the present disclosure, the device setting system 100 is provided with the server apparatus 3, but the present disclosure is not limited thereto. The device setting system 100 may be provided with a plurality of device setting apparatuses connected communicatably with each other. For example, the device setting system 100 may be provided with the device setting apparatus 1A and the device setting apparatus 1B, and the device setting apparatus 1A may include the setting storage 301. Further, each of the device setting apparatus 1A and the device setting apparatus 1B may include the setting storage 301.

(2) As described with reference to FIG. 1, in the embodiment of the present disclosure, the device setting apparatus 1 includes the device setting apparatus 1A and the device setting apparatus 1B, but the present disclosure is not limited thereto. The device setting apparatus 1 may include a plurality of device setting apparatuses. For example, the device setting apparatus 1 may include three of more device setting apparatuses.

The present disclosure provides a device setting apparatus, a device setting method, a device setting system and a non-transitory computer-readable recording medium storing a device setting program, and is industrially applicable thereto.

What is claimed is:

1. A device setting apparatus comprising:
a receiver to receive first conference information defining a conference;
a setting storage to store second conference information that is different than the first conference information and setting information of a device in association with each other;
an extractor to extract the setting information corresponding to the first conference information from among the setting information stored in the setting storage; and
a setting executor to execute setting processing of the device based on the setting information.

2. The device setting apparatus according to claim 1, wherein
each of the first conference information and the second conference information includes conference room name information indicating a conference room name of a conference room in which a conference is being held, and conference name information indicating a conference name, and wherein
the extractor extracts the setting information corresponding to the conference room name information and the conference name information of the first conference information from among the setting information stored in the setting storage.

3. The device setting apparatus according to claim 2, wherein
each of the first conference information and the second conference information further includes at least one of starting date and time information and ending date and time information, and the extractor extracts the setting information from among the setting information stored in the setting storage based on at least one of the starting date and time information of the first conference information and the ending date and time information of the first conference information, wherein
the starting date and time information indicates a conference starting date and time that is the date and time at which the conference starts, and the ending date and time information indicates a conference ending date and time that is the date and time at which the conference ends.

4. The device setting apparatus according to claim 2, wherein
each of the first conference information and the second conference information further includes participant name information that indicates a name of a participant of the conference, and the extractor extracts the setting information corresponding to the participant name information of the first conference information from among the setting information stored in the setting storage.

5. The device setting apparatus according to claim 1, wherein
each of the first conference information and the second conference information includes conference room name information indicating a conference room name of a conference room in which a conference is being held and access destination information indicating an access point of the device, and wherein
the extractor extracts the setting information corresponding to the conference room name information of the first conference information, and the access destination information of the first conference information from among the setting information stored in the setting storage.

6. The device setting apparatus according to claim 1, wherein
each of the first conference information and the second conference information indicates at least one of a conference room name, a conference name, a name of a organizer, a name of a participant, a department name of the participant corresponding to the name of the participant, a conference starting date and time, a conference ending date and time, and an access point of the device.

7. The device setting apparatus according to claim 1, wherein
the device includes at least one of a camera, a microphone, a speaker, a display, a card reader and a network connection device.

8. A device setting method executed by a device setting apparatus provided with a setting storage to store second conference information defining a conference and setting information of a device in association with each other, wherein
the device setting method includes
receiving, by the device setting apparatus, first conference information that is different than the second conference information,
extracting, by the device setting apparatus, the setting information corresponding to the first conference information from among the setting information stored in the setting storage, and
setting, by the device setting apparatus, to execute setting processing of the device based on the setting information.

9. A device setting system comprising:
a server apparatus; and
a device setting apparatus connected comunicatably with the server apparatus, wherein the server apparatus includes a setting storage to store second conference information defining a conference and setting information of a device in association with each other, wherein the device setting apparatus is provided with a receiver to receive first conference information that is different than the second conference information, an extractor to extract the setting information corresponding to the first conference information from among the setting information stored in the setting storage of the server apparatus, and a setting executor to execute setting processing of the device based on the setting information.

10. A non-transitory computer-readable recording medium storing a device setting program, the device setting program causing a computer included in a device setting apparatus to function as:
a receiver to receive first conference information defining a conference,
a setting storage to store second conference information that is different than the first conference information and setting information of a device in association with each other,
an extractor to extract the setting information corresponding to the first conference information from among the setting information stored in the setting storage, and
a setting executor to execute setting processing of the device based on the setting information.
